(19) United States
(12) Patent Application Publication
(10) Pub. No.: US 2015/0360128 A1
(43) Pub. Date: Dec. 17, 2015

(54) Online Gaming System Using Advertisement

(71) Applicants: Natanel Eisenberg, Montgomery, WV (US); Frank Lee Legg, Victor, WV (US); Christopher Lee Legg, Victor, WV (US)

(72) Inventors: Natanel Eisenberg, Montgomery, WV (US); Frank Lee Legg, Victor, WV (US); Christopher Lee Legg, Victor, WV (US)

(21) Appl. No.: 14/306,465

(22) Filed: Jun. 17, 2014

(51) Int. Cl. A63F 13/61

(52) U.S. Cl. CPC A63F 13/61

(57) ABSTRACT

An online gaming system that utilizes a wide area network to enable players to solve games involving advertisement images includes a computer server connected to the internet. An advertiser database is stored in memory having a plurality of advertisement records and a player database having a plurality of player records. In game play, a player selects an advertisement image and it is displayed for a predetermined period on a game window and then transformed into a plurality of ad fragments displayed adjacent the game window in the manner of puzzle pieces. The player drags selected ad fragments onto the game window based on recollection of the briefly displayed ad until the advertisement image is completely reconstructed. The player may play against other online players who selected the same advertisement image, against a timer in multiple complexity levels, or other variations. The player can redeem points for rewards.

### BACKGROUND OF THE INVENTION

This invention relates generally to online or mobile app related gaming systems and, more particularly, to an online gaming system that enables players to play games of skill in reassembling scattered images of an advertising image in competition with other players or against a timer.

Advertisers seek as many opportunities as possible to place their advertising message in front of consumers. Traditionally, traditional advertisements include billboards along high traffic roads, print ads in newspapers and magazines, or audio/visual messages on radio and television, and the like. More recently, new outlets for advertising have made use of the internet, such as on social media or search engines. Another popular use of the internet is for playing games, either against other internet users, against the player based on time, or against the computer. Gaming websites may also include advertisements that display offers of goods or services.

Although assumably effective for their intended purposes, the existing forms of advertisements do not require a consumer to look intently at the advertisement for a period of time or to manipulate or work with the advertisement for an extended period beyond just looking at it. Further, existing forms of advertising do not provide incentives to a consumer just for viewing or listening to the advertisement.

Therefore, it would be desirable to have an online gaming system that utilizes the internet to enable players to puzzle type games involving advertisement images. Further, it would be desirable to have an online gaming system that requires a user to memorize an advertisement image that then gets scrambled for the user to reassemble during game play. In addition, it would be desirable to have an online gaming system that provides incentives to consumers as motivation to repeatedly submit to the same or different advertisements.

### SUMMARY OF THE INVENTION

An online gaming system that utilizes a wide area network to enable players to solve games involving advertisement images according to the present invention includes a computer server connected to the internet. An advertiser database is stored in memory having a plurality of advertisement records and a player database having a plurality of player records. In game play, a player selects an advertisement image and it is displayed for a predetermined period on a game window and then transformed into a plurality of ad fragments displayed adjacent the game window in the manner of puzzle pieces. The player drags selected ad fragments onto the game window based on recollection of the briefly displayed ad until the advertisement image is completely reconstructed. The player may play against other online players who selected the same advertisement image, against a timer in multiple complexity levels, or other variations. The player can redeem points for rewards.

Specifically, the present invention may be implemented as an internet website or mobile application. The system and methodology turns advertisements into games called “AdGames” and awards prizes to winners of these games. All games are skill based rather than change based. All games are free to play and winners will receive prizes at no cost to them, prizes being products, discounts and coupons, or cash. Advertisers will pay to have their ads included in the games. Other vendors may contribute prizes as a means of advertising their products or services.

In summary, the online gaming system enables advertisers to use incentives such as cash prizes, coupons, or other rewards to urge consumer's to study and memorize an advertisement image with the understanding that the longer a consumer studies the ad image (or even works with it repeatedly), the more likely the consumer is to make a purchasing decision. Conversely, the online gaming system enables consumers to receive the incentives while playing a fun and challenging game of skill against other players online or against a timer.

Therefore, a general object of this invention is to provide an online gaming system that utilizes advertisements as the object of one or more game processes.

Another object of this invention is to provide an online gaming system, as aforesaid, that urges a user to memorize an advertisement image that then gets scrambled in order to reassemble the advertising image during game play.

Still another object of this invention is to provide an online gaming system, as aforesaid, that provides an advertisement image to be reassembled in a timed competition between players or by a single player in a timed competition with himself.

Yet another object of this invention is to provide an online gaming system, as aforesaid, that awards prizes to winners of the advertisement game competitions.

A further object of this invention is to provide an online gaming system, as aforesaid, that is free to players and funded by advertisers seeking to make their advertisements into objects of game play.

A still further object of this invention is to provide an online gaming system, as aforesaid, that uses a puzzle motif to cause a player to dwell on the message of an advertisement for an extended period of time.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram illustrating an online or mobile app gaming system accessible by advertisers and players;

FIG. 2 is another block diagram of the online gaming system as in FIG. 1 illustrating how the system is accessible over the internet and operated as a network server system;

FIG. 3 is a block diagram illustrating the contents of a computer memory according to the present invention;

FIG. 4 is a flowchart illustrating the logic performed by a processor to perform a setup and initiation process of the system;

FIG. 5 is a flowchart illustrating the logic performed by the processor to operate a Competition “AdBreak” process;

FIG. 6 is a flowchart illustrating the logic performed by the processor to operate a “Timed AdBreak” process;

FIG. 7 is a flowchart illustrating the logic performed by the processor to operate a “AdSmash” process.

FIG. 8 is an illustration of an advertisement image being displayed prior to be scrambled into a plurality of fragment; and

FIG. 9 is an illustration of an advertisement image fragmented into a plurality of ad fragments that are then positioned outside the game window.

### DESCRIPTION OF THE PREFERRED EMBODIMENT

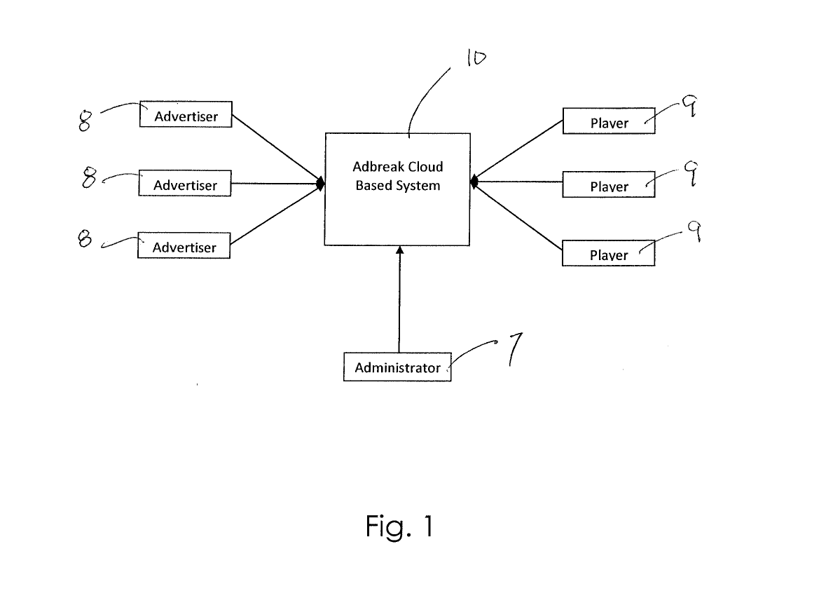

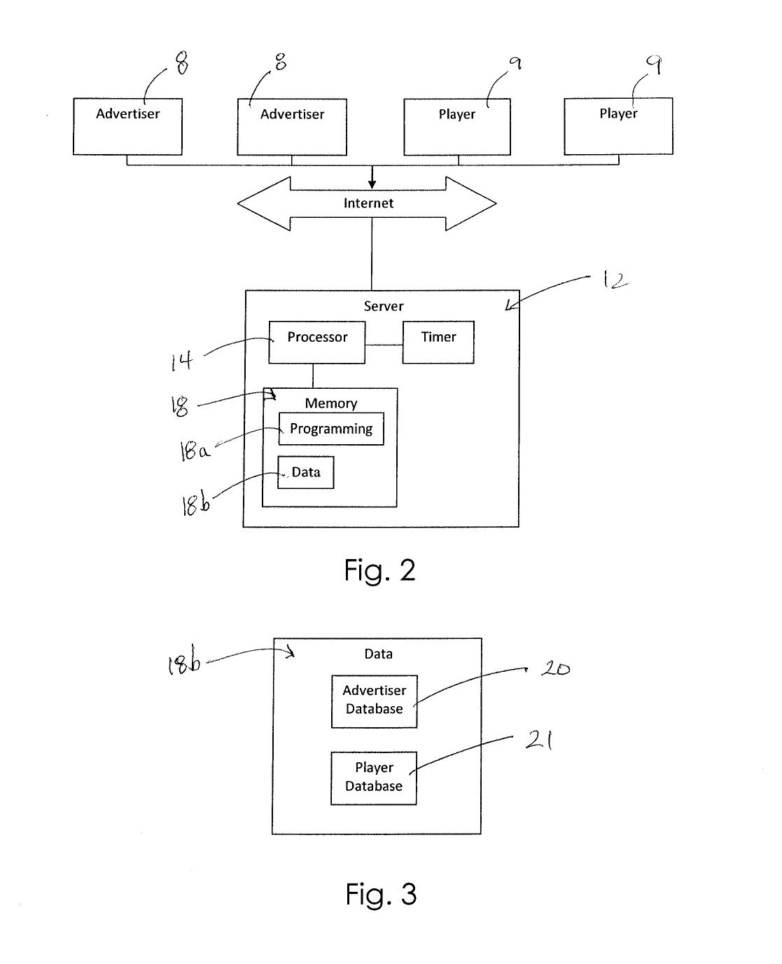

An online gaming system that utilizes a wide area network to enable players to solve games of skill involving advertisement images according to the present invention will now be described with reference to FIGS. 1 to 9 of the accompanying drawings. The online gaming system 10 includes at least one computer 12, such as a network server, operably connected to the internet and accessible by remote computers in a traditional manner (FIG. 1). Specifically, the online gaming system 10 is designed to be used by advertisers 8 and by players 9 to play games derived from and involving advertisements submitted by advertisers 8. The system 10 may be configured and managed by an administrator 7 having security access to all aspects of the computer, memory, including data and programming.

The computer 12 may include a memory 18 configured to store a plurality of programming instructions 18a and a processor 14 configured to selectively execute the program instructions in a manner that operates the system 10 as will be described below. The memory 18 may also be structured so as to store a plurality of data structures 18b such as one or more databases and data that may be stored and manipulated by operation of the programming instructions.

Data structures 18b stored in the memory 18 may include, but not be limited to the databases described below. The system 10 may include an advertiser database 20 that may include a plurality of advertisement records associated with a plurality of advertisers 8 (FIG. 3). Each advertisement record may include one or more advertisement images. Similarly, the system 10 may include a player database 21 having a plurality of player records. Each player record may include, but not be limited to, login data, contact data, reward data, game type and level completed, and the like.

The databases may be filled with respective data by advertisers 8 and players 9 who use the system 10. Preferably, both players and advertisers may be required to sign up as members before authorization is given to utilize the system 10 since players may need to choose and receive rewards and advertisers will need to upload advertising information for use in the system 10. Once a member, an advertiser may log in—such as with a username and password—and choose to upload advertisement images to the advertiser database. Similarly a player may sign up, play a selected game, and receive rewards.

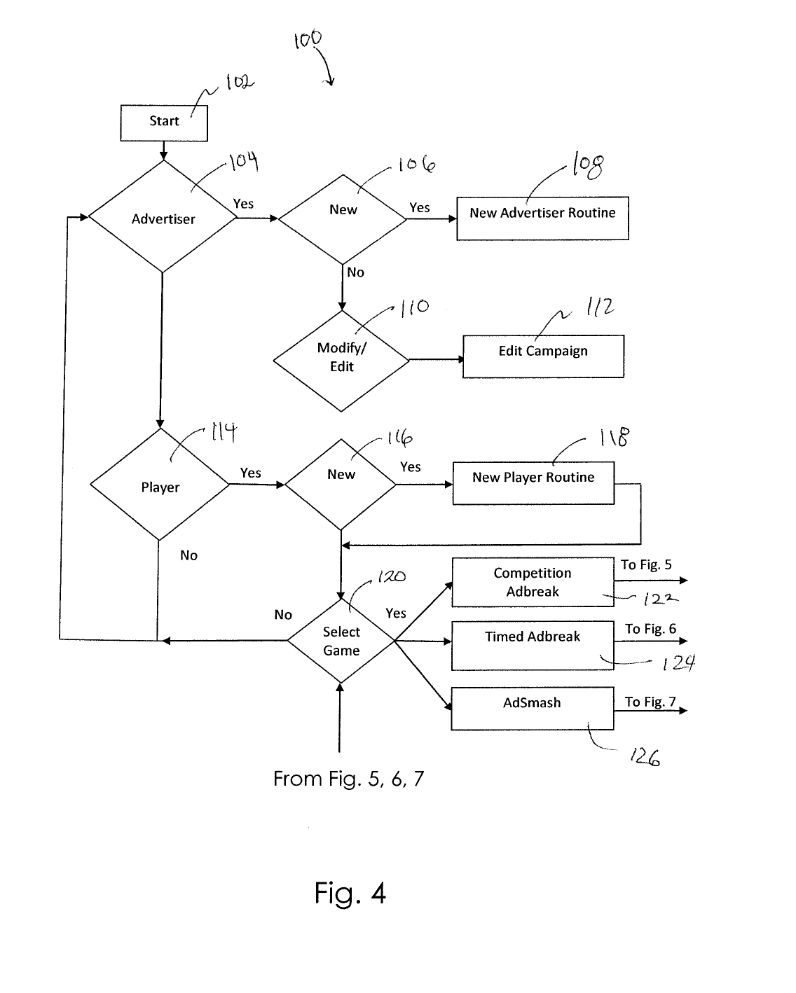

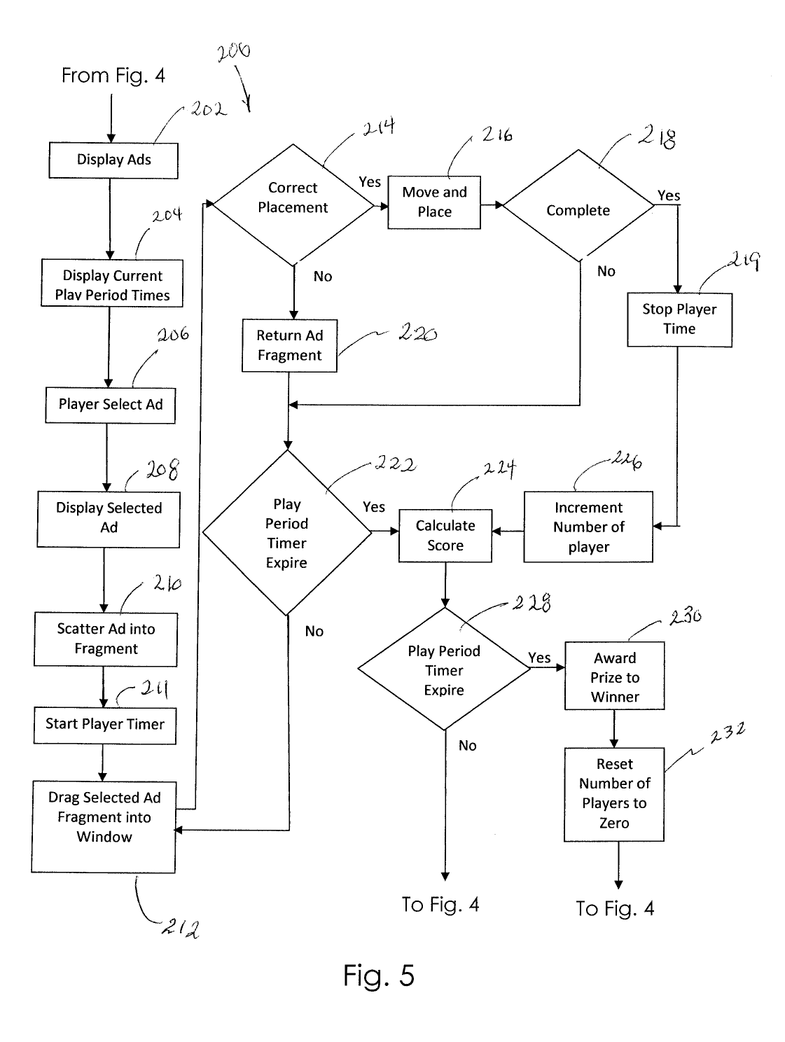

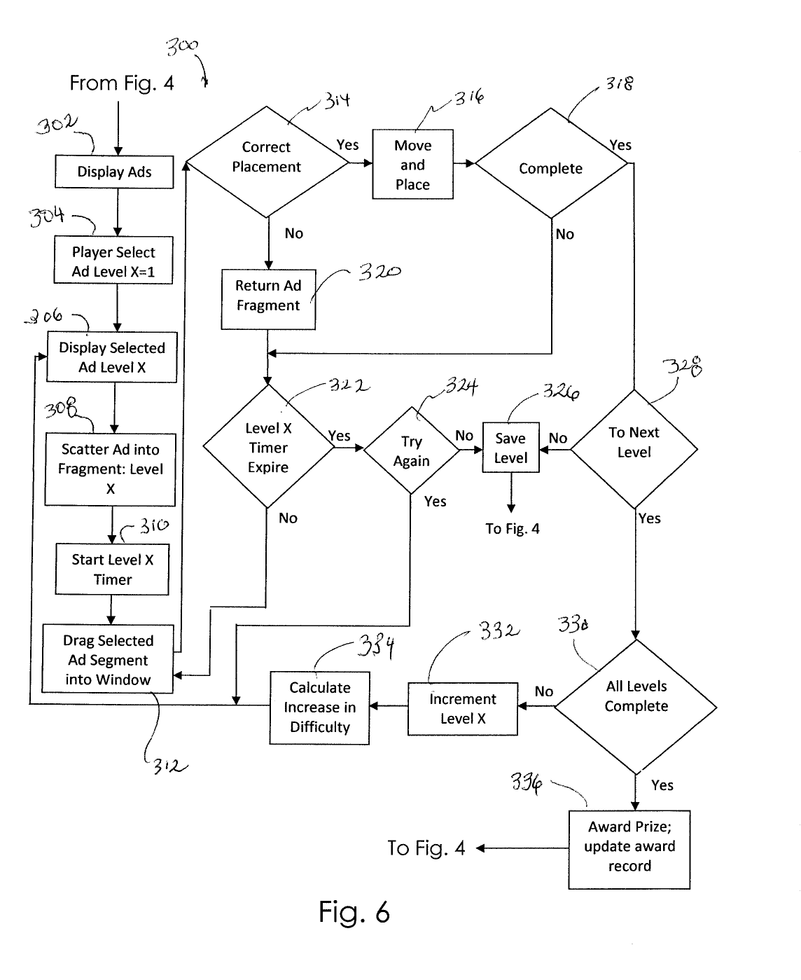

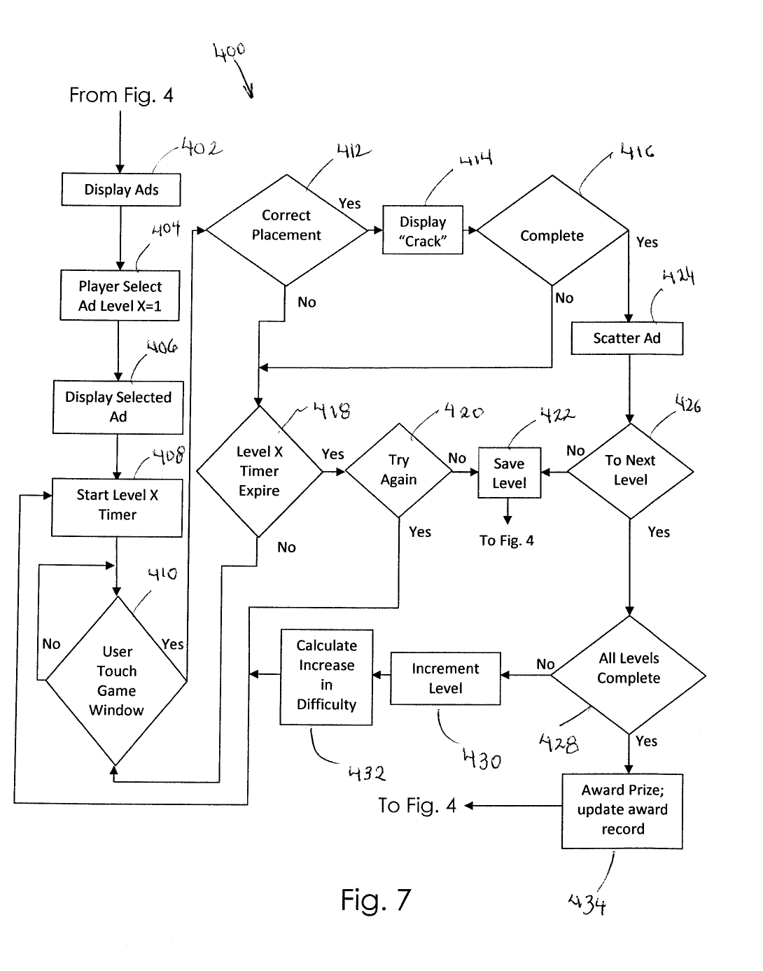

Operation of the system 10 according to an exemplary process is illustrated in the flowcharts of FIGS. 4 through 7 and will be described below. It is understood that the steps of the process are carried out by the processor 14 executing programming stored in memory 18. A setup and game initiation process 100 includes programming for receiving advertiser and player data into respective databases as described above and for selecting game play options.

As shown in FIG. 4, the setup and initiation process 100 begins at step 102, such as when a user logs in to the online website or mobile app. The process 100 proceeds to step 104 where the processor 14, under program control, determines if the user is an advertiser, such as by a menu driven or touch screen user interface.

If it is determined that the user is an advertiser, then the process 100 proceeds to step 106; otherwise, the process 100 proceeds to step 114. At step 106, the processor 14 determines if the advertiser is new to the system and unregistered and, if so, the process 100 proceeds to step 108. Otherwise, the process 100 proceeds to step 110.

At step 108, the new advertiser has opportunity to enter advertisement record data, such as contact information, and to upload advertisement image data and the like. Each new advertiser may set up an Advertiser Account where they will essentially purchase a specific number of “winners” for an upfront cost and will be responsible for delivering all prizes to respective winners. They may also indicate items to be showcased and made available for bid by players. The system may implement an “Advertiser Store” where items sponsored by advertisers may be purchased by consumers based on points earned during game play or for cash. At step 110, the processor 14 determines if the member advertiser desires to edit previously entered advertisement record data and, if so, proceeds to step 112 where an advertisement record may be modified.

At step 114, the processor 14, under program control, determines if a user accessing the system 10 is a player and, if so, the process 100 proceeds to step 116; otherwise, the process 100 returns to step 104 and begins again. At step 116, the processor determines if the player is new and unregistered; if so, the process 100 proceeds to step 118. Otherwise, the process 100 proceeds to step 120. At step 118, the player supplies new player data such as login information, physical contact information, award records, and the like. A player account is created and stored as a data structure in memory 18. A respective player account (also known as a “player record) may include the number of points earned in a respective game, notifications, play data, rewards, login information, address information, demographic information, and the like.

At step 120, the processor 14 determines what type of game the player desires to play. In one embodiment, a user has a choice of reassembling a fragmented advertisement by playing against other players online (“Competition AdBreak”), restoring a fragmented advertisement by playing against a timer with multiple skill levels (“Timed AdBreak”), and completing a “crack pattern” associated with an advertisement image (“AdSmash”). Step 120 may be a “menu tree” with which the player chooses which game to play or may be a touch screen selection menu. If the choice is for Competition AdBreak, then the process 100 proceeds to step 122 which is accomplished by process 200 illustrated in FIG. 5. If the choice is for Timed AdBreak, then the process 100 proceeds to step 124 which is accomplished by process 300 illustrated in FIG. 6. If the choice is for Competition AdBreak, then the process 100 proceeds to step 126 which is accomplished by process 400 illustrated in FIG. 7.

The process 200 corresponding to the Competition AdBreak game is illustrated in FIG. 5 and begins with step 202. At step 202, the processor 14 causes advertisement images available for game play to be displayed to the player. More particularly, the processor 14, under program control, selects all of the images that have been uploaded by advertisers into the advertiser database 20 or, in some embodiments, a subset of images in case the total number is unfeasibly large to display. The process then proceeds to step 204. At step 204, the processor 14 may direct an amount of time remaining to play the game before the game ends and awards are issued to be displayed for each advertisement image. In other words, each displayed image (called a “thumbnail”) will have an amount of time left to play using that advertisement image. It is understood that other players may have already selected a respective advertisement image and be in the process of playing the game with that respective image. The process 200 proceeds to step 206.

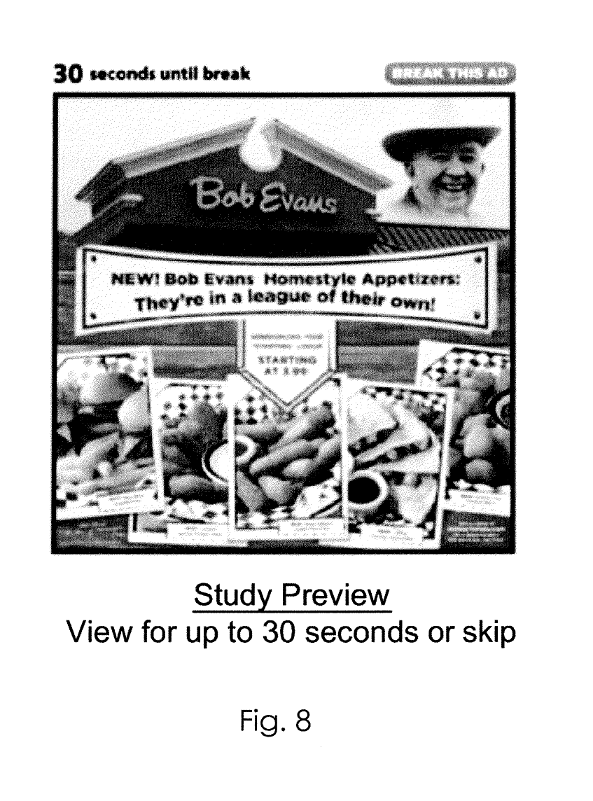

At step 206, the processor 14 receives an advertisement image selected by a player, the image having been selected using the user interface, such a mouse, touch screen, or the like, all activity being carried out through internet or mobile phone connections. In one embodiment, the processor 14 may select which image is selected for game play by all players across the internet or for each new player beginning game play. The process 200 proceeds to step 208. At step 208, the processor 14 causes the selected advertisement image to be displayed for a predetermined period of time in the game window on the player's screen, for instance, for 30 seconds, to enable the player to attempt to commit as many details to memory as possible. FIG. 8 shows an example of an advertisement image being displayed to the player. The process 200 proceeds to step 210.

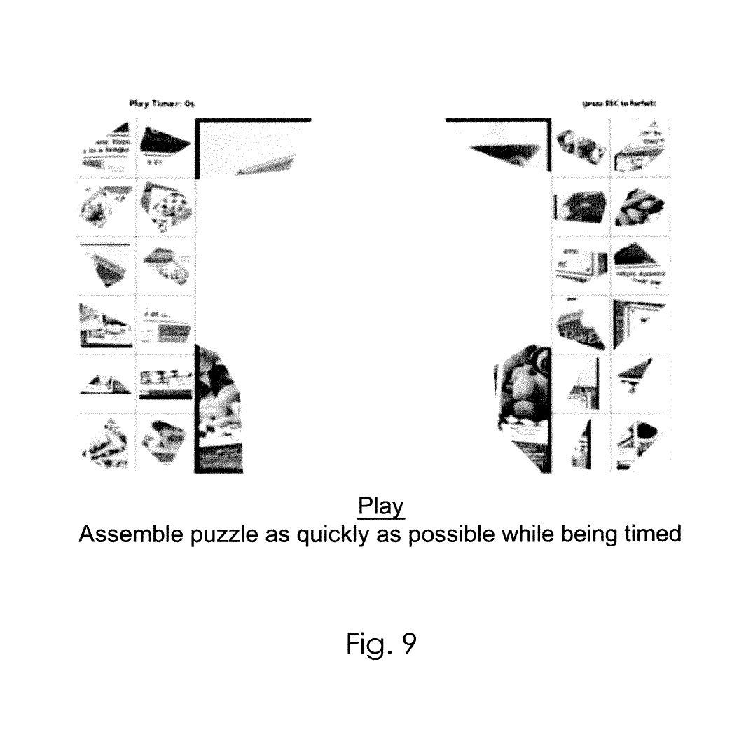

Then, at step 210, the processor causes the selected advertisement image to be instantly scrambled into a plurality of separate fragments (referred to herein as “ad fragments”) which are then positioned randomly around the outside boundary of the game window. FIG. 9 shows an example of an advertisement image fragmented into a plurality of ad fragments that are then positioned outside the game window. In one embodiment, the four corner pieces may remain in their predetermined positions on the game window.

The process 200 proceeds to step 211 where a “player timer” is started and will keep track of how long it takes the player to reassemble the entire selected advertisement image. The process 200 then proceeds to step 212. At step 212, the processor 14 receives input from the player that is indicative of the player dragging a selected ad fragment onto the game window. In other words, the player is attempting to restore the original advertisement image to its original and complete form. The process 200 proceeds to step 214.

At step 214, the processor 14 determines if the player input indicates a respective ad fragment was properly placed in its associated and predetermined location. If so, the process 200 proceeds to step 216; otherwise the process proceeds to step 220 where the processor 14 causes the selected ad fragment to return to the same or a different position outside the game window. It is understood that correct placement may be accepted if placement is “close” to an acceptable and predetermined degree. From step 220, the process 200 continues to step 222. At step 216, the processor 14 causes the correctly placed ad fragment to be permanently placed in its correct position on the game window for the duration of the game. The process 200 proceeds to step 218.

At step 218, the process 200 determines if reassembly of the entire advertisement is complete as a result of the most recent correct placement of an ad fragment. If so, the process 200 proceeds to step 219; otherwise, the process 200 proceeds to step 222. At step 222, the processor 14 determines if the time for game play with respect to the selected advertisement image has expired. It is understood that multiple players may be playing the competition oriented game type associated with process 200 simultaneously or during the timed period of game play. If the time period for game play has expired, then the process 200 continues to step 224; otherwise, the process 200 returns to step 212 where the player again selects an ad fragment and attempts to place it correctly on the game window, as described above.

At step 219—which follows a determination that the selected ad image has been entirely reassembled—the processor 14 causes the player timer to be stopped, indicating the time it took the player to reassemble the entire selected advertisement image. The process 200 continues to step 226. At step 226, the processor 14 increments a data structure indicative of the number of players that have completed reassembly within the game period so far. The process 200 continues to step 224.

At step 224, a player's score is calculated. In its simplest form, the score is based on the speed with which the selected advertisement image was reassembled after it was scattered into fragments. However, in some embodiments, there may be other activities that generate scoring options. A player's score may be stored in an appropriate data structure associated with the respective player in the player database 21. The process 200 continues to step 228 where the processor 14 again determines if the play period time is expired. If so, then the process 200 proceeds to step 230; otherwise, control is returned to process 100 illustrated in FIG. 4.

At step 230, the processor 14 determines the overall winner of the competition completed during the play period. It is understood that multiple players across the country may have played the game and received respective scores, now stored in the player database. The processor 14 is able to access respective records and determine which player had the highest score and, as a result, determine a winner. At step 230, a prize may be awarded to the player determined to be the winner, such as a cash prize.

It is understood that other prizes and benefits may be awarded to the winner or to all or selected players, such as coupons, discounts, physical prizes, and the like. For instance, gift prizes may be mailed to a player, an associated prize value may be added to a player account (to the player account's cash tab, gift tab, or coupon tab), or other incentives given.

The process 200 continues to step 232 where the processor 14 causes the data structure associated the number of players having played the current game is reset to zero and control is returned to the initiation process 100 illustrated in FIG. 4 and described previously.

The process 300 corresponding to the “Timed AdBreak” game is illustrated in FIG. 6 and begins with step 302. At step 302, the processor 14 causes advertisement images available for game play to be displayed to the player. More particularly, the processor 14, under program control, selects all of the images that have been uploaded by advertisers into the advertiser database 20 or, in some embodiments, a subset of images in case the total number is unfeasibly large to display. It is understood that available images may be associated with a system of skill levels, e.g. level 1, level 2, level 3, and so on, with each higher level being more complicated and requiring a higher level of skill by the player to reassemble the image within a predetermined time also associated with a respective level.

At step 304, the processor 14 receives an advertisement image selected by a player, the image having been selected using the user interface, such a mouse, touch screen, or the like, all activity being carried out through internet or mobile phone connections. It is understood that the image selected initially is a level 1 image. In one embodiment, the processor 14 may select which image is selected for level 1 game play or subsequently for other levels. The process 300 proceeds to step 306. At step 306, the processor 14 causes the selected advertisement image to be displayed for a predetermined period of time in the game window on the player's screen, for instance, for 30 seconds, to enable the player to attempt to commit as many details to memory as possible. The process 300 proceeds to step 308.

Then, at step 308, the processor causes the selected advertisement image to be instantly scrambled into a plurality of separate fragments (referred to herein as “ad fragments”) which are then positioned randomly around the outside boundary of the game window. In one embodiment, the four corner pieces may remain in their predetermined positions on the game window. The process 300 proceeds to step 310 where a “level x timer” is started and will keep track of how long the player is given to reassemble the entire selected advertisement image for the current level, the allotted time being a predetermined amount of time associated with the current skill level. The process 300 then proceeds to step 312. At step 312, the processor 14 receives input from the player that is indicative of the player dragging a selected ad fragment onto the game window. In other words, the player is attempting to restore the original advertisement image to its original and complete form. The process 300 proceeds to step 314.

At step 314, the processor 14 determines if the player input indicates a respective ad fragment was properly placed in its associated and predetermined location. If so, the process 300 proceeds to step 316; otherwise the process proceeds to step 320 where the processor 14 causes the selected ad fragment to return to the same or a different position outside the game window. It is understood that correct placement may be accepted if placement is “close” to an acceptable and predetermined degree. From step 320, the process 300 proceeds to step 322. At step 316, the processor 14 causes the correctly placed ad fragment to be permanently “snapped into place” in its correct position on the game window for the duration of the game. The process 300 proceeds to step 318.

At step 318, the process 300 determines if reassembly of the entire advertisement is complete as a result of the most recent correct placement of an ad fragment. If so, the process 300 proceeds to step 328; otherwise, the process 300 proceeds to step 322. At step 322, the processor 14 determines if the time for game play for the current level (“level x”) has expired. If so, then control shifts to step 324; otherwise, the process 300 returns to step 312 where the processor 14 will again receive input indicative of the player dragging another ad fragment onto the game window as described above. This looping logic continues until either the selected advertisement is completely reassembled or until the level x timer expires.

If at step 322, the processor determined that the level x timer has expired and the process 300 continues to step 324, then the processor 14 determines if the player wishes to try again to reassemble the same fragmented advertisement image. If so, then the process 300 returns to step 306 where the complete ad image is displayed for a predetermined time before being scattered. If not, then the process 300 proceeds to step 326 where settings associated with the current level are saved to an appropriate player record before control is returned to process 100 illustrated in FIG. 1.

At step 328, the processor 14 determines if the player desires to proceed on to the next level and continue game play. If so, then the process 300 proceeds to step 330. Otherwise, the process 300 proceeds to step 326 where settings associated with the current level are saved to an appropriate player record before control is returned to process 100 illustrated in FIG. 1. At step 330, the process 300 determines if all skill levels available to be played are complete and, if so, the process 300 proceeds to step 336. Otherwise, the process 300 proceeds to step 332.

At step 332, the level (i.e. “level x”) is incremented—meaning, the next higher level will hereafter be played, including selecting an image from the next higher level, applying an associated timer for the level, etc. The process 300 then proceeds to step 334 at which respective settings for the next higher level are determined and applied. The process 300 then returns control to step 306 where the next ad image is displayed and the process of reassembly essentially starts over. In some embodiments, control may be returned to 304 to enable the player to select the ad for the next level before the next level timer begins as described previously.

At step 336, an award may be granted to a player who has completed all levels and appropriate player records are updated.

The process 400 corresponding to the “AdSmash” game is illustrated in FIG. 7 and begins with step 402. At step 402, the processor 14 causes advertisement images available for game play to be displayed to the player. More particularly, the processor 14, under program control, selects all of the images that have been uploaded by advertisers into the advertiser database 20 or, in some embodiments, a subset of images in case the total number is unfeasibly large to display. It is understood that available images may be associated with a system of skill levels, e.g. level 1, level 2, level 3, and so on, with each higher level being more complicated and requiring a higher level of skill by the player to reassemble the image within a predetermined time also associated with a respective level.

At step 404, the processor 14 receives an advertisement image selected by a player, the image having been selected using the user interface, such a mouse, touch screen, or the like, all activity being carried out through internet or mobile phone connections. It is understood that the image selected initially is a level 1 image. In one embodiment, the processor 14 may select which image is selected for level 1 game play or subsequently for other levels. The process 400 proceeds to step 406. At step 406, the processor 14 causes the selected advertisement image to be displayed in the game window on the player's screen and, in some embodiments, to play an audio file associated with the displayed advertisement. The process 400 proceeds to step 408.

At step 408, the processor 14 causes a “level x timer” to be started to keep track of how long the player is given to complete the current level, the allotted time being a predetermined amount of time associated with the current skill level. The process 300 then proceeds to step 410. At step 410, the processor 14 receives input from the player that is indicative of the player touching a particular location on the game window although the player may make such a selection with a mouse or other input means. As indicated previously, the AdSmash game style involves a player touching the game window and the image showing a “crack” along a juncture of what would have been adjacent ad fragments as described in the other game styles. After receiving the user input indicative of a player's touch of the game window, the process 400 proceeds to step 412.

At step 412, the processor 14 determines if the user input is indicative of a correct placement of the touch of the game window and, if so, the process 400 continues to step 4141; otherwise, the process 400 proceeds to step 418. At step 414, the processor 14 causes a “crack” to be displayed on the game window at the point touched the player, the crack representing the point of intersection of adjacent ad fragments as described previously. It is understood that the programming may require repeated display of crack segments (as caused by numerous touches of the screen by user) before the intersection of all ad segments will be lined with “cracks.” After displaying a respective crack, the process 400 continues to step 416.

At step 416, the processor 14 determines if all of the cracks indicative of division lines between respective ad segments have been displayed and, if so, the process 400 proceeds to step 424 indicative that the game is complete. Otherwise, the process 400 proceeds to step 418. At step 418, the processor 14 determines if the time for game play for the current level (“level x”) has expired. If so, then control shifts to step 420; otherwise, the process 400 returns to step 410 where the processor 14 will again receive input indicative of the player touching or choosing a point on the game window as described above. This looping logic continues until either the selected advertisement is completely “crack filled” or until the level x timer expires.

If at step 418, the processor determined that the level x timer has expired and the process 400 continues to step 420, then the processor 14 determines if the player wishes to try again to completely “crack” the selected advertisement image. If so, then the process 400 returns to step 406 where the complete ad image is displayed completely with no cracks apparent. If not, then the process 400 proceeds to step 422 where settings associated with the current level are saved to an appropriate player record before control is returned to process 100 illustrated in FIG. 1.

At step 424 (after it is determined that a level is complete and all of the cracks dividing an advertisement image into fragments), the processor 14 causes the selected image to be scattered into a plurality of ad fragments. The process 400 then proceeds to step 426. At step 426, the processor 14 determines if the player wishes to go on to the next level and, if so, proceeds to step 428. Otherwise, the process 400 continues to step 422 where settings associated with the current level are saved to an appropriate player record before control is returned to process 100 illustrated in FIG. 1.

At step 428, the processor determines if all skill levels available to be played are complete and, if so, the process 400 proceeds to step 434. Otherwise, the process 400 proceeds to step 430.

At step 430, the level (i.e. “level x”) is incremented—meaning, the next higher level will hereafter be played, including selecting an image from the next higher level, applying an associated timer for the increased level, etc. The process 400 then proceeds to step 432 at which settings for the next higher level are determined and applied. The process 400 then returns control to step 406 where the next ad image is displayed and the process of reassembly essentially starts over. In some embodiments, control may be returned to 404 to enable the player to select the ad for the next level before the next level timer begins as described previously. At step 434, an award may be granted to a player who has completed all levels and appropriate player records are updated.

The online gaming system has a website interface that allows players and advertisers to interact using a variety of on-screen tabs associated with various cash, gift, and coupon tabs.

### Cash Tab

The Cash Tab stores all cash prizes that are won. A notification is sent to this tab when a new cash prize is sent here, similar to a Facebook® notification. This will also send a Push Notification for the mobile apps. All cash prizes are accumulated here until the player receives them into his PayPal balance by inputting a PayPal e-mail address and clicking ‘Receive’. There will be a counter that keeps count of total cash winnings received throughout the course of every year. Players are only permitted to receive up to $600 worth of cash and gift prizes. Once players reach $600, they will be able to continue to play games but will be ineligible to win further prizes until January 1 of the following year.

### Gift Tab

Gifts may be any physical item such as gift cards or merchandise. They are sent to this tab in the same fashion as the cash prizes. A notification appears on this tab for all Gift rewards. Within the Gift Tab, each gift will have its own small section with information about the gift, and the list will continue to add up as gifts are won. For each gift, the basic information about the AdBreak that was won is displayed—including the winning time, total plays, play period length, and exact time of win. There is also an option to see more details such as the puzzle image, etc. The Advertiser Name is displayed with a profile picture, which direct to the advertiser's profile. On the right side, details about the gift are shown, including a picture and description. The player has 30 days to redeem the gift upon winning it; after that the gift disappears from the tab. By clicking the Redeem button, a disclaimer screen explains that the Advertiser has been verified and that any information provided is only to deliver the gift. The player is then prompted to enter an e-mail address or a mailing address that is sent to the Advertiser for delivery. The Advertiser is responsible for delivering the gift prize. As players win gifts, the retail price of all gifts add up over the year, similar to the total cash amount in the Cash Tab. See Legal Constraints to learn more about the limitations.

### Coupon Tab

The Coupon Tab displays all coupons that are saved during game play. This tab does not require notifications; the player manually chooses to save coupons or not. These coupons are ‘mobile coupons’ and are to be used in-store. These coupons can perform in any way the Advertiser sees fit, as long as they can easily be used directly from the user's mobile device from the Coupon Tab. It could be a discount code for the cashier to type in or an online discount code, or a bit more direct—tapping ‘Redeem’ displays a bar code for the cashier to scan directly from the phone screen along with a countdown timer; once the countdown finishes the coupon is expired and disappears from the tab.

### Points

As with most gaming apps, points are awarded to Consumers for a variety of actions throughout game play of all AdBreaks and AdSmashes. These points accumulate in the Points Tab and can be used to redeem more prizes. Actions for receiving points (numerical values to be determined at a later date):
Completing a certain level of any Timed AdBreak or AdSmash (higher numerical value of points for higher levels of Timed AdBreaks and AdSmashes).
For AdBreaks, assemble 4 pieces in under 8 second
For AdBreaks, assemble a piece that doesn't touch any other piece (in the middle of the canvas
Clicking the URL link on the End Screen of a Competition AdBreak
Playing any game without muting the audio
Completing an AdSmash on the Study Preview of any AdBreak (Competition or Timed) before the 30 second timer is finished
Points for 2^{nd} 3^{rd}, 4^{th}, and 5^{th} place in Competition AdBreaks
Numerical value of all points is doubled on Competition AdBreaks

The gaming system website may include a “Points Tab” that keeps track of the points of respective players. As players accumulate points, the total amount of points is displayed on the button for the Points Tab. However, once clicking on the Points Tab, the player will see that the points are broken into individual advertisers. This is because the points earned from each advertiser's games are specific for that advertiser, e.g. play a game hosted by Pepsi®, the points earned from that game are attributed to Pepsi®. The only way to earn points for an advertiser is to play that advertiser's games. Within the Points Tab, a list of all advertisers that have been played is shown, along with the amount of points earned for each advertiser. Clicking on the advertiser name or profile picture directs the player to the advertiser's profile. If the advertiser has items available in their advertiser store, the player can visit this store to redeem points for items. The items in the advertiser store are similar to gifts or may also be cash prizes, but are acquired when the consumer wins an item by bidding points in an auction instead of playing a game. Only verified advertisers are permitted to offer advertiser store gift items.

### Advertiser Store

The online gaming system 10 may also host an “Advertiser Store” that accessible to players through user interface website. More particularly, players can reach the advertiser stores through the Points Tab or through an advertiser profile. Within an advertiser store, various gift or cash prize items are shown that are uploaded by the advertiser. The items are available for auction and laid out similar to any other online store. Players may only use earned “advertiser points” to bid on these items.

For each listed item, there is a picture and description of the item that also includes the retail price, and quantity remaining of the item available. There is a starting bid of the advertiser's choice when uploading the items. The advertiser may also showcase an item for a specific time frame before the auction begins to allow players the opportunity to earn points for bidding. If the player has enough points available to bid on an item, he may place a bid, which will deduct the points away from the available points to use (referred to as a “Score Meter.” The first time that a player bids on a certain item, the player must have all the points from the ‘current bid’ available in the score meter to enter the auction. Once entered, the player can continue to raise the bid as it rises. For example, if the current bid is 500, a player must have at least 500 available in his Score Meter to place his first bid and enter the auction—at which point the bid placement amount is deducted from the Meter. If the current bid is then raised by someone else to 505, the player can then bid again from 500 to 510 and only 10 points would be deducted from the Score Meter while bidding, regardless of how many bids are placed throughout the auction. At the end of the auction, the winning bidder is sent the gift item or the Cash item into a Cash Tab. Players who didn't win the item are then returned the points to their Score Meter.

Accordingly, the online gaming system 10 enables advertisers to use incentives such as cash prizes, coupons, or other rewards to urge player to study and memorize an advertisement image with the understanding that the longer a consumer studies the ad image (or even works with it repeatedly), the more likely the player is to make a purchasing decision. Conversely, the online gaming system 10 enables consumers to receive the incentives while playing a fun and challenging game of skill against other players online or against a timer.

It is understood that while certain forms of this invention have been illustrated and described, it is not limited thereto except insofar as such limitations are included in the following claims and allowable functional equivalents thereof.

1. An online gaming system that utilizes a wide area network to enable players to solve games involving advertisement images, comprising:
a computer server having a processor connected to the wide area network and that provides a user interface to the network;
programming and data structures stored in a computer readable memory in data communication with said processor,
an advertiser database stored in said memory that includes a plurality of advertisement records associated with a plurality of advertisers;
a player database stored in said memory that includes a plurality of player records;
programming in said memory that, when executed by said processor, causes said processor to:
receive a game play request from a current player through said user interface;
receive a selected ad image from said current player;
transform said selected ad image into a plurality of ad fragments; and
receive input from said current player indicative of restoring said plurality of ad fragments back into said selected ad image.

2. The online gaming system as in claim 1, wherein said programming, when executed by said processor, causes said processor to:
display, through said user interface, selectable ad images taken from said plurality of advertisement records;
wherein said selected ad image is selected by said current player from said selectable ad images displayed through said user interface.

3. The online gaming system as in claim 2, wherein said programming, when executed by said processor, causes said processor to display said plurality of ad fragments adjacent a game window when said ad image has been transformed into said plurality of ad fragments.

4. The online gaming system as in claim 3, wherein said current player input includes drag movement data indicative of said current player moving a selected ad fragment onto said game window.

5. The online gaming system as in claim 4, wherein said programming, when executed by said processor, causes said processor to:
determine if said drag movement data associated with moving a respective selected ad fragment matches a predetermined location on said game window;
permanently display said respective selected ad fragment at said predetermined location on said game board if said drag movement data associated with moving a respective selected ad fragment matches a predetermined location on said game window; and
return said respective ad fragment to a position adjacent said game window if said drag movement data associated with said respective selected ad fragment does not match said predetermined location on said window.

6. The online gaming system as in claim 5, wherein said programming, when executed by said processor, causes said processor to:
determine if all said plurality of ad fragments have been properly positioned on said game window;
repeat said programming to receive drag movement data and to determine if said drag movement data is indicative that a respective selected ad fragment is in a predetermined location on said game window until all of said plurality of ad fragments are properly positioned on said game window.

7. The online gaming system as in claim 5, comprising:
a timer electrically connected to said processor, said timer configured to count down from a predetermined time when actuated;
wherein said programming, when executed by said processor, causes said processor to:
actuate said timer to begin counting down when said selectable ads are displayed;
after determining if said drag movement data associated with moving a respective selected ad fragment matches a predetermined location on said game window, determine if said predetermined time has expired.

8. The online gaming system as in claim 7, wherein said programming, when executed by said processor, causes said processor to calculate a game score associated with said current player if all of said plurality of ad fragments are properly positioned on said game window or if said predetermined time has expired.

9. The online gaming system as in claim 8, wherein said programming, when executed by said processor, causes said processor to save said calculated score associated with said current player to a respective player record associated with said current player in said player database.

10. The online gaming system as in claim 2, wherein:
said programming instruction to display said selectable ad images is to display said selectable ad images associated with a skill level;
said selected ad image is selected by said current player from said selectable ad images associated with said skill level displayed through said user interface.

11. The online gaming system as in claim 10, wherein said programming, when executed by said processor, causes said processor to display said plurality of ad fragments adjacent a game window when said ad image has been transformed into said plurality of ad fragments.

12. The online gaming system as in claim 11, wherein said current player input includes drag movement data indicative of said current player moving a selected ad fragment onto said game window.

13. The online gaming system as in claim 12, wherein said programming, when executed by said processor, causes said processor to:
determine if said drag movement data associated with moving a respective selected ad fragment matches a predetermined location on said game window;
permanently display said respective selected ad fragment at said predetermined location on said game board if said drag movement data associated with moving a respective selected ad fragment matches a predetermined location on said game window; and
return said respective ad fragment to a position adjacent said game window if said drag movement data associated with said respective selected ad fragment does not match said predetermined location on said window.

14. The online gaming system as in claim 13, wherein said programming, when executed by said processor, causes said processor to:
determine if all said plurality of ad fragments have been properly positioned on said game window;
repeat said programming to receive drag movement data and to determine if said drag movement data is indicative that a respective selected ad fragment is in a predetermined location on said game window until all of said plurality of ad fragments are properly positioned on said game window.

15. The online gaming system as in claim 14, comprising:
a timer electrically connected to said processor, said timer configured to count down from a predetermined time when actuated;
wherein said programming, when executed by said processor, causes said processor to:
actuate said timer to begin counting down when said selected ad is transformed into a plurality of ad segments;
after determining if said drag movement data associated with moving a respective selected ad fragment matches a predetermined location on said game window, determine if said predetermined time has expired; and
if said predetermined is determined to have been expired, determine if said current player wishes to play again and, if so, return to said programming instruction to display said selectable ads associated with said skill level.

16. The online gaming system as in claim 14, wherein said programming, when executed by said processor, causes said processor to:
if all said plurality of ad fragments have been properly positioned on said game window, increment said skill level; and
if said skill level has been incremented, return to said programming instruction to display said selectable ads associated with said skill level.

17. An online gaming system that utilizes a wide area network to enable players to solve games involving advertisement images, comprising:
a computer server having a processor connected to the wide area network and that provides a user interface to the network;
programming and data structures stored in a computer readable memory in data communication with said processor,
an advertiser database stored in said memory that includes a plurality of advertisement records associated with a plurality of advertisers;
a player database stored in said memory that includes a plurality of player records;
programming in said memory that, when executed by said processor, causes said processor to:
receive a game play request from a current player through said user interface;
display selectable ad images from said plurality of advertisement records associated with a skill level;
receive a selected ad image selected by said current player;
display said selected ad image in a game window and play an audio file associated with said selected ad image;
transform said selected ad image into a plurality of ad fragments;
remove said plurality of ad fragments from said game window; and
receive input from said current player indicative of a position of a respective ad fragment.

18. The online gaming system as in claim 17, wherein said programming, when executed by said processor, causes said processor to:
determine if said input from said current player matches a predetermined location of a respective ad fragment and, if so, display said respective ad fragment on said game window; and
if said respective ad fragment is displayed on said game window, display a connection segment extending away from said displayed respective ad fragment.

19. The online gaming system as in claim 18, wherein said programming, when executed by said processor, causes said processor to:
determine if all said plurality of ad fragments have been displayed on said game window; and
repeat said programming to receive input from said current player and to determine if said input matches a predetermined location of a respective ad fragment until all of said plurality of ad fragments are properly displayed on said game window.

20. The online gaming system as in claim 18, comprising:
a timer electrically connected to said processor, said timer configured to count down from a predetermined time when actuated;
wherein said programming, when executed by said processor, causes said processor to:
actuate said timer to begin counting down when said selected ad is displayed;
after determining if said user input matches a predetermined location of a respective ad fragment, determine if said predetermined time has expired.

21. The online gaming system as in claim 20, wherein said programming, when executed by said processor, causes said processor to:
increment said skill level if all said plurality of ad fragments have been properly displayed on said game window; and
if said skill level has been incremented, return to said programming instruction to display said selectable ads associated with said skill level.
